(19) United States
(12) Patent Application Publication
(10) Pub. No.: US 2010/0147823 A1
(43) Pub. Date: Jun. 17, 2010

(54) OVEN CONTROL SYSTEM WITH GRAPHICAL DISPLAY

(75) Inventors: JOHN ROBERT ANDERSON, STEVENSVILLE, MI (US); JENNIFER L. BONUSO, SAINT JOSEPH, MI (US); CHRISTOPHER D. ELDER, STEVENSVILLE, MI (US); WALLACE JAMES ELSTON, III, PAW PAW, MI (US); ANTHONY EARL JENKINS, COVERT, MI (US); ANTONY JOHN KIRK, SAINT JOSEPH, MI (US); BRANDON LYNN SATANEK, STEVENSVILLE, MI (US); STEVEN MICHAEL SWAYNE, CHATTANOOGA, TN (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/336,602

(22) Filed: Dec. 17, 2008

(51) Int. Cl. A21B 1/00

(52) U.S. Cl. 219/391

(57) ABSTRACT

A cooking appliance includes an oven cavity adapted to be used in cooking foods and a control system includes a display device for presenting available programming options to a user through pictorial images, such as in prompting a user to input information relating to a food product to be cooked. The display device also presents graphical instructions relating to cooking the food product. A controller is provided for establishing a cooking operation within the oven cavity based on the selected programming options.

### BACKGROUND OF THE INVENTION

1. Field of the Invention

The present invention pertains to the art of cooking appliances and, more particularly, to a cooking appliance including a user interface and control system for initiating and controlling a cooking operation.

2. Description of the Related Art

Over the years, there have been many advances in the art of cooking appliances. Various heat sources, such as convection air, microwave and IR heating elements have been used, in one way or another, to perform a cooking operation. Mechanical components such as switches, thermostats and other controls have been replaced, or at least supplemented, by electronic control systems. Rotary knobs are slowly giving way to touch pads and touch screen displays. Many new features have been added to the cooking appliance, such as preprogrammed operations, recipes, and multi-stage cooking operations. Many ovens, ranges and the like available on the market today incorporate, to certain degrees, programmable features intended to aid a consumer in performing cooking operations. Some electronic control systems for cooking appliances enable a consumer to input certain cooking information, such as cooking modes, times and temperatures, with the inputted information generally being presented in a viewable display area and used to establish a cooking operation.

As set forth above, there have been various developments in the art of cooking appliances directed to aiding a consumer in performing certain cooking operations effectively. However, there still exists a need for a more user friendly system for controlling the operation of a cooking appliance. More specifically, there exists a need for an electronic control system which functions to prompt a user, as needed, to input certain cooking information in a convenient and clear manner, and then automatically controls the cooking appliance to perform the desired operation. In addition, there is a need for an oven with a display for providing a user with simple visual instructions on how to perform tasks, such as properly inserting a temperature probe.

### SUMMARY OF THE INVENTION

The present invention is directed to a system and method of controlling a cooking appliance, in particular an oven of a cooking appliance. The method includes presenting, in sequence, a plurality of display screens. At least one screen of the plurality of display screens shows a pictorial image for prompting a user to input information relating to a food product to be cooked. In addition, another display screen provides graphical instructions relating to cooking the food product to guide a user to perform a cooking related step. For example, the graphical instructions may show a user how to position a temperature probe in a food product to be cooked. Appropriate cooking parameters are then determined based on the information input by the user. A cooking operation is then performed in an oven cavity of the cooking appliance using the appropriate cooking parameters.

Additional objects, features and advantages of the present invention will become more readily apparent from the following detailed description of the preferred embodiments of the invention when taken in conjunction with the drawings wherein like reference numerals refer to corresponding parts in the several views.

### BRIEF DESCRIPTION OF THE DRAWINGS

FIG. 1 is a perspective view of a combination cooking oven having a control panel constructed in accordance with the present invention;

FIG. 2 is an exploded perspective view of a convection heating system employed in the oven of FIG. 1;

FIG. 3 is an enlarged view of a control panel employed in connection with the wall oven of FIG. 1 illustrating operation with a programming button in accordance with an embodiment of the present invention;

FIGS. 4A and 4B illustrate an initial display sequence in accordance with an embodiment of the invention;

FIGS. 5A-5D illustrate an additional, potential program sequence in accordance with an embodiment of the invention;

FIGS. 6A and 6B illustrate a further block diagram of potential program sequences in accordance with an alternate embodiment of the invention;

FIGS. 7A and 7B illustrate another block diagram of program sequences for inputting upper and lower cooking time parameters in accordance with an embodiment of the invention;

FIGS. 8A and 8B illustrate screen displays showing pictorial images in accordance with the embodiments of the invention;

FIGS. 9A-9D illustrate another block diagram showing display screens corresponding to a cooking operation in accordance with the embodiments of the invention;

FIG. 10 is a color image of the screen display of FIG. 5B;

FIGS. 11A-11E depict images of various levels of doneness to be displayed as the image of FIGS. 10 and 5B;

FIG. 12 is an image of the screen display of FIG. 6B; and

FIG. 13 is an image of the screen display of FIG. 8A.

### DETAILED DESCRIPTION OF THE PREFERRED EMBODIMENTS

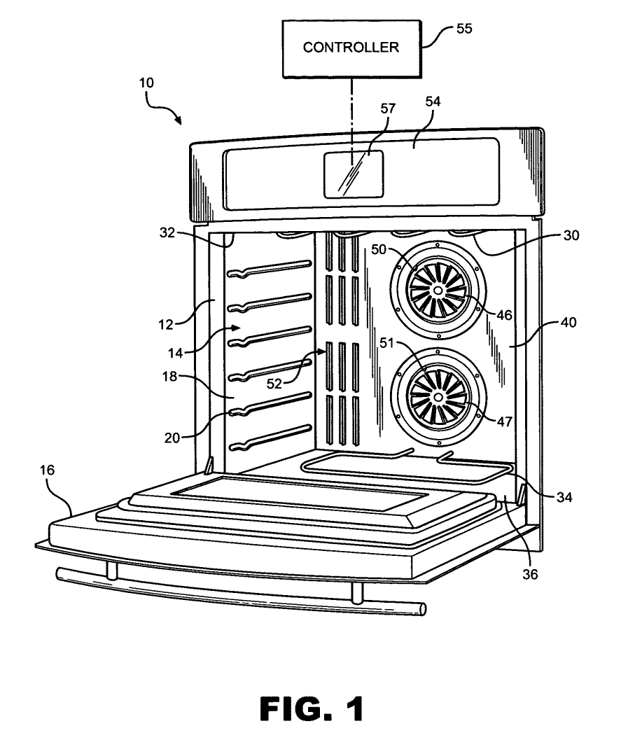

With initial reference to FIG. 1, a combination radiant heat and convection oven of the present invention is generally indicated at 10. In the preferred embodiment shown, oven 10 is a wall-mounted or built-in oven, and includes a cabinet 12 which forms an oven cavity 14. A door 16 is pivotally mounted to cabinet 12 for selectively closing oven 10 and sealing oven cavity 14. Oven cavity 14 includes opposing side walls 18 having a plurality of spaced rails 20 for supporting repositionable racks (not shown) in a manner known in the art.

In accordance with the present invention, oven 10 also includes an upper broil element 30 mounted adjacent an upper wall 32 of oven cavity 14 and a lower bake element 34 mounted adjacent a lower wall 36 of oven cavity 14. In a preferred embodiment of the invention, upper broil element is constituted by a 3600 watt resistive-type electric heating element, while lower bake element 34 is constituted by a 2800 watt resistive-type electric heating element. A convection cover 40 is adapted to be mounted over first and second motor driven fans 46 and 47 within oven cavity 14 as will be discussed more fully below. Fans 46 and 47 are constituted by multi-speed electric fans which can be continuously operated or pulsed. In accordance with the most preferred embodiment of the invention, fans 46 and 47 are centrally mounted and vertically arranged within oven cavity 14, such that first and second fans 46 and 47 are aligned with and positioned at respective first and second circular apertures 50 and 51 formed in convection cover 40. In the preferred embodiment, convection cover 40 also includes a plurality of spaced angled louvered openings 52 on either side of first and second fans 46 and 47, with louvered openings 52 being adapted to distribute heated air evenly throughout oven cavity 14 as will be discussed in more detail below. A user interface 54 is arranged in communication with a controller 55 and provides a user with a means for controlling oven 10. Interface device 54 includes a display 57. In the embodiment shown, display 57 is constituted by a touch screen, as will be described in detail below.

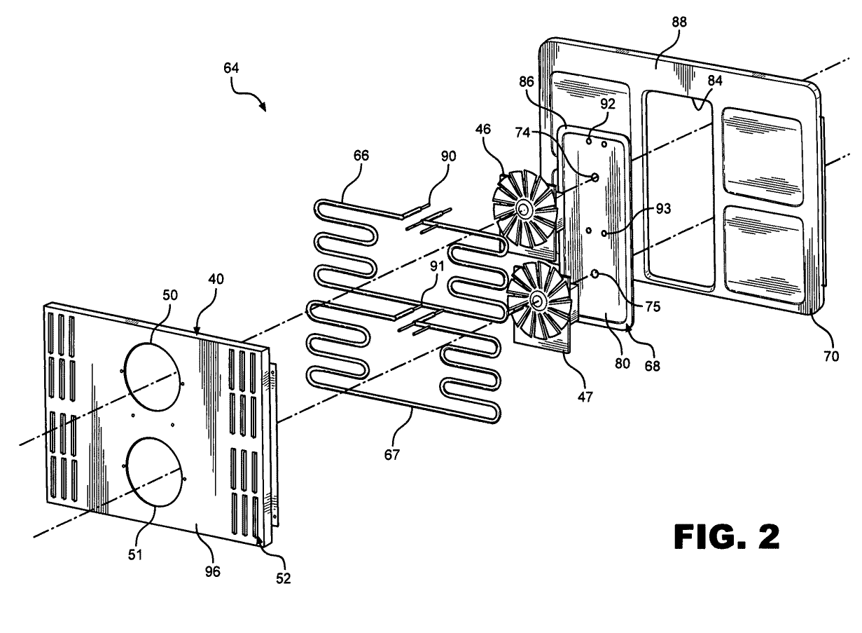

An overall convection heating system 64 utilized in connection with the present invention will now be discussed with reference to FIG. 2. In general, convection heating system 64 includes convection cover 40, a first upper convection heater 66, a second lower convection heater 67, first and second fans 46 and 47, a fan mounting panel 68 and a back panel 70. First and second fans 46 and 47 are mounted through respective apertures 74 and 75 to fan mounting panel 68. Fan mounting panel 68 includes a recessed main body portion 80 which nests within a cut-out portion 84 of back panel 70, and a peripheral edge portion 86 of fan mounting panel 68 abuts a front face portion 88 of back panel 70 about the periphery of cut-out portion 84. First and second convection heaters 66 and 67 are then positioned about first and second fans 46 and 47 respectively, with electric connector portions 90 and 91 of first and second convection heaters 66 and 67 fitting through pairs of openings 92 and 93 in fan mounting panel 68 respectively. In a preferred embodiment of the invention, both first and second convection heaters 66 and 67 are constituted by 3600 watt resistive-type electric heating elements. With convection cover 40 mounted to establish a back wall for oven cavity 14, back panel 70 is secured behind cabinet 12, whereby first and second convection heaters 66 and 67 are located behind convection cover 40 and first and second fans 46 and 47 fit within respective first and second apertures 50 and 51.

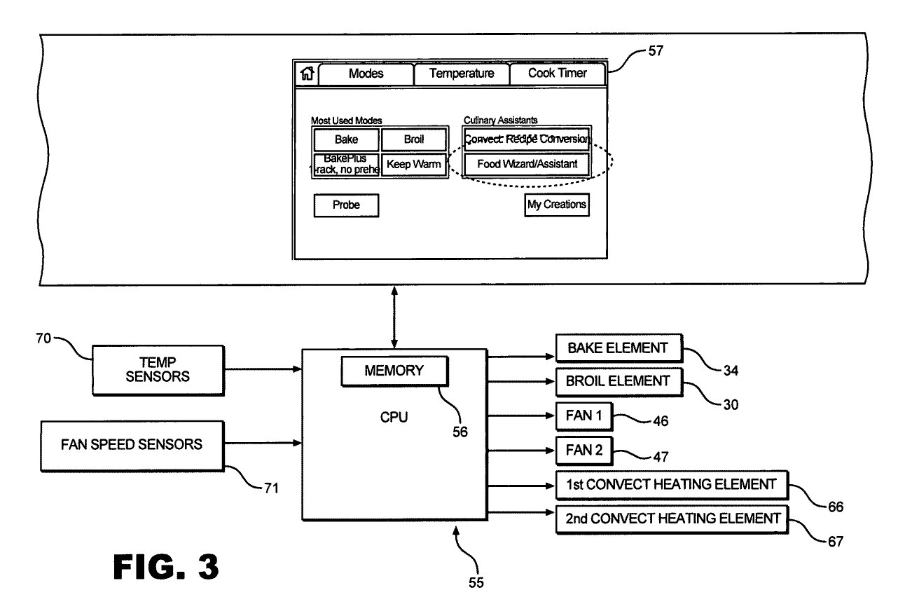

A controller 55 having a memory 56 is in communication with user interface device 54 for controlling the operation of upper broil element 30, lower bake element 34, first and second convection heaters 66 and 67, and the first and second motor driven fans 46 and 47 (see FIG. 3) based on user inputs and both temperature and fan speed sensors 70 and 71. Interface 54 allows a user to input information based on prompts from a sequence of display screens. As illustrated in FIG. 3, the invention provides for at least a bake mode, a broil mode, a no preheat one-rack bake mode, a convection recipe conversion mode and a warming mode. As will be detailed more fully below, the present invention is particularly directed to the manner in which oven 10 is programmed and operated by prompting a user for specific information using a “Food Wizard/Assistant” mode.

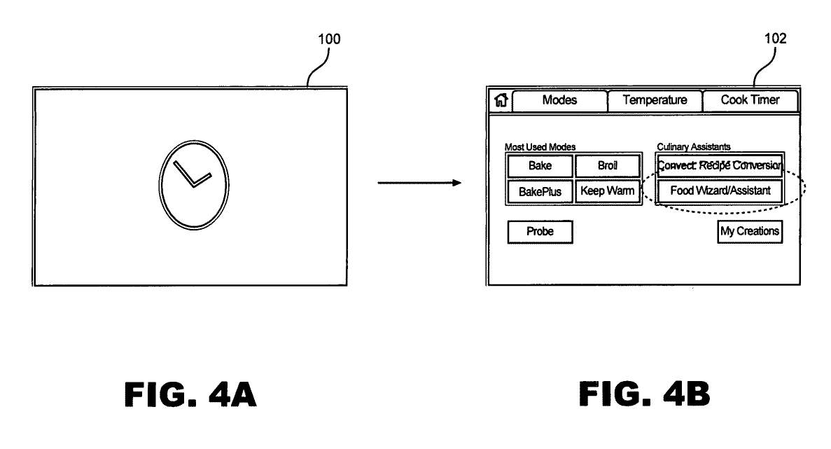

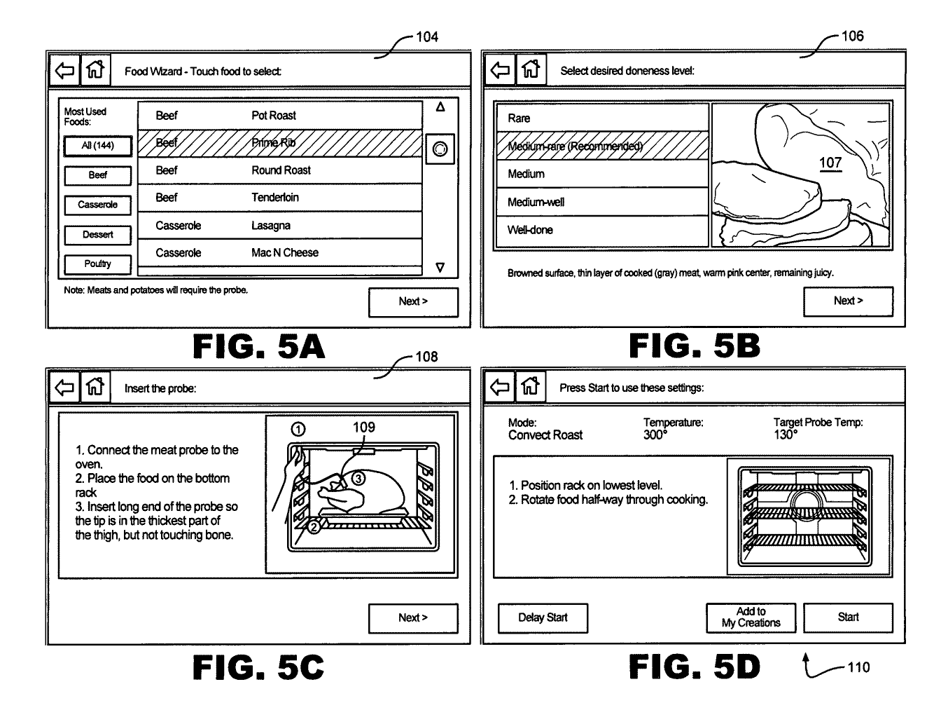

The manner in which oven 10 operates in accordance with the embodiments of the invention will be described in detail below, particularly with reference to the block diagrams of FIGS. 4A-9D. Initially, FIGS. 4A, 4B and 5A-5D are referenced in describing one potential programming sequence in accordance with the invention. When oven is not in use, display 57 may show an initial screen 100 that is a view of a clock, graphically represented in FIG. 4A. A user activates interface 54 by touching screen 100. As shown, when interface 54 is activated, screen 100 changes to screen 102, as shown in FIG. 4B, which presents various operating options for oven 10. With screen 102 being displayed, a user can select a desired operating command by simply touching a portion of screen 102 in which a keyword is indicated. As shown, the user can preferably select “Bake”, “BakePlus”, “Broil”, “Keep Warm,” “Probe,” “Convection Recipe Conversion,” “Food Wizard/Assistant” or “My Creations.” Other keywords may be displayed based on the modes the user most often employs. Further details of the operation of oven 10 upon selecting the “Food Wizard/Assistant” option in accordance with the invention will be presented more fully below.

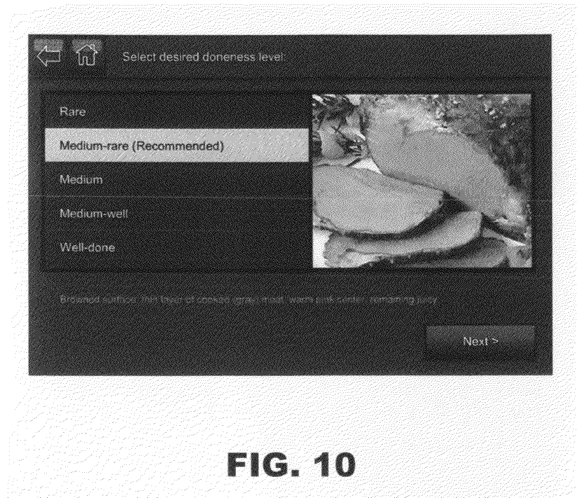

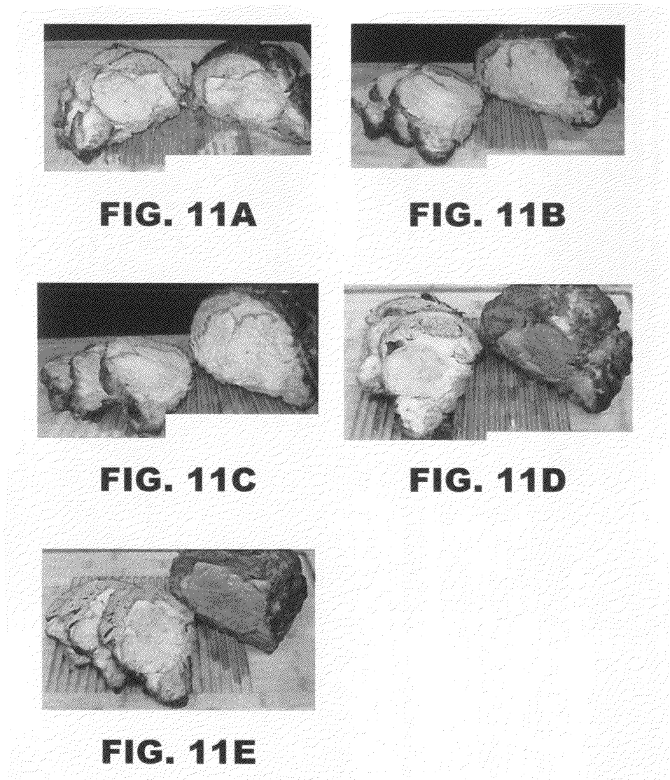

Once the “Food Wizard/Assistant” option is selected, display 57 automatically shifts to screen 104, as shown in FIGS. 5A-5D, wherein a user is prompted to select the type of food to be cooked. From screen 104, the user may select from a variety of food categories, as shown on the left of the screen. The categories listed may include “Beef,” “Casserole,” “Dessert,” “Poultry,” or “All.” When a category is selected, various food items within the selected category are presented on the right of the category list. As shown on screen 104, a user may choose to view all food items in a single list by selecting “All.” Scrolling through the list can be performed with up and down arrow key zones (not labeled) located near the edge of screen 104. Here, for exemplary purposes, the “All” category has been selected and the “Beef-Prime Rib” food item has been selected. Following the selection of “Prime Rib” on screen 104, display 57 shifts to screen 106, as shown in FIG. 5B, whereupon display 57 prompts the user to select the desired doneness of the prime rib. As shown, the user may select “Rare,” “Medium-rare (Recommended),” “Medium,” “Medium-well,” or “Well-done.” As the user touches a desired doneness, a pictorial image 107 of a prime rib at the selected level of doneness is displayed. In accordance with the most preferred embodiment of the invention, pictorial image 107 is shown in full color, as shown in FIG. 10, so a user can make an educated selection as to the level of doneness. For the sake of completeness of the disclosure, various images showing the various levels of doneness for a prime rib are shown in FIGS. 11A-11E. A written description of each is also provided on screen 106. For example, if the user selects “Rare,” the pictorial image will show a rare prime rib. For exemplary purposes, FIG. 5B indicates that the prime rib has been selected for medium-rare doneness. The pictorial image and description indicate to a user what a Medium-rare prime rib would look like. As shown, a Medium-Rare prime rib is described as having a “Browned surface, thin layer of cooked (gray) meat, warm pink center, remaining juicy.” When the doneness selection has been made the user may proceed to the next screen by touching the button, “Next,” on display 57.

As shown in FIG. 5C, screen 108 follows selection screen 106. Screen 108 is a description and graphical illustration demonstrating to a user how to position the food within the oven cavity and how to properly insert a temperature probe 109 into the food product. For exemplary purposes, screen 108 illustrates a turkey and explains to a user to “Connect the meat probe to the oven,” “place the food on the bottom rack,” and “insert the long end of the probe so the tip is in the thickest part of the thigh, but not touching the bone.” A pictorial or graphical image is provided on the left side of the screen showing a visual depiction of each of the steps described. This description and graphical display assists the user by teaching the user to insert the probe properly so the cooked food product will provide the results desired by the user.

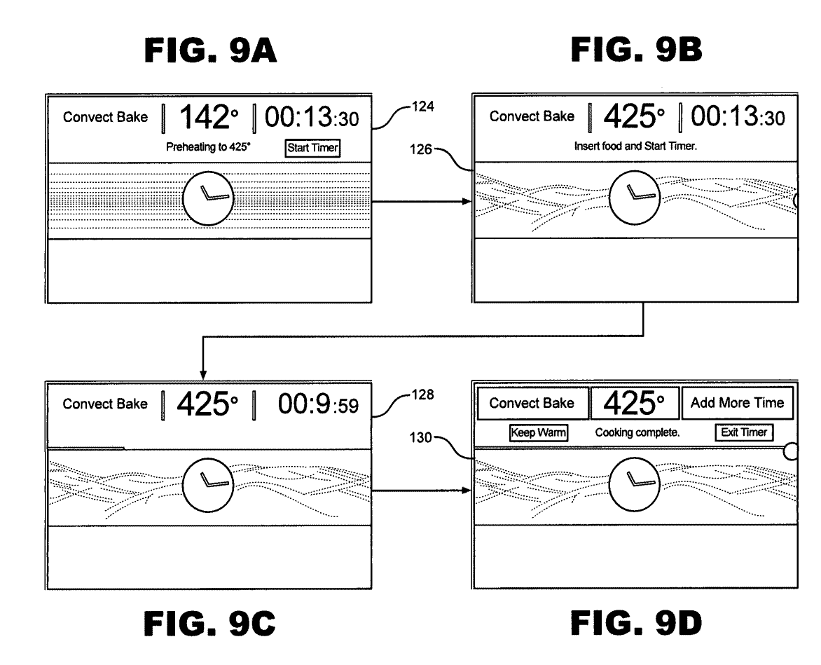

When the user has successfully inserted the temperature probe 109 and positioned the food in the oven 10, the user selects the “Next” button by touching it on screen 108 of display 57. The next screen 110, as shown in FIG. 5D, displays the settings as determined by controller 55. In particular, controller 55 determines the operation and speed of first and second motor driven fans 46 and 47 and each of the plurality of heating elements 30, 32, 66 and 67 in order to accommodate the desired user result based on the user inputs. Screen 110 also preferably indicates the parameters determined by controller 55. In the example shown, the selected mode is “Convect Roast,” the proper cooking temperature has been determined to be 300° F. and the target probe temperature is 130° F. Additional user instructions may be provided to advise the user to perform a step, such as rotating, flipping, or basting the food product during cooking. Another graphical illustration may be provided to show the user how to perform the step. The user may then touch “Start” to commence the cooking operation or “Delay Start” to commence the cooking operation at a later time. In addition, the user has the option of saving the cooking parameters for the food product by choosing “Add to My Creations.” If the user selects “Start,” screen 110 then shifts to a first of a series of cooking screens, which will be described in detail hereinafter with reference to FIGS. 9A-9D.

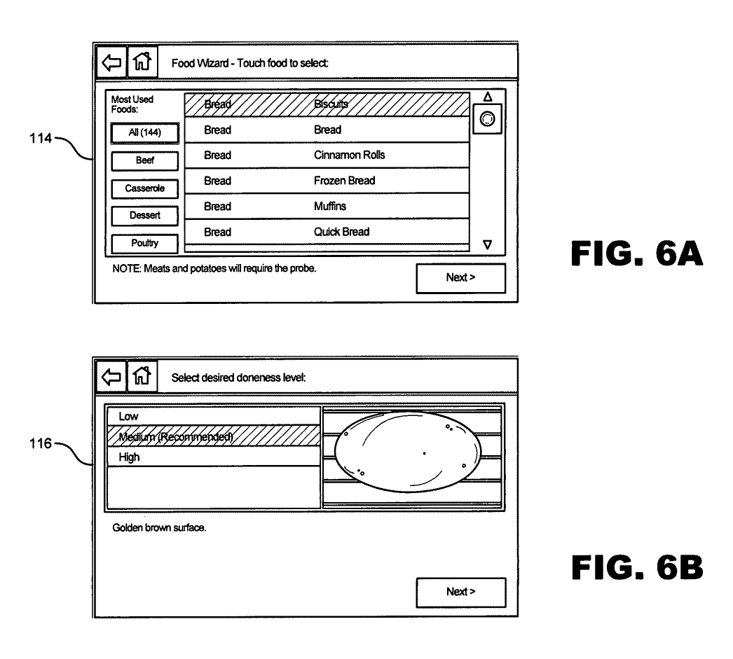

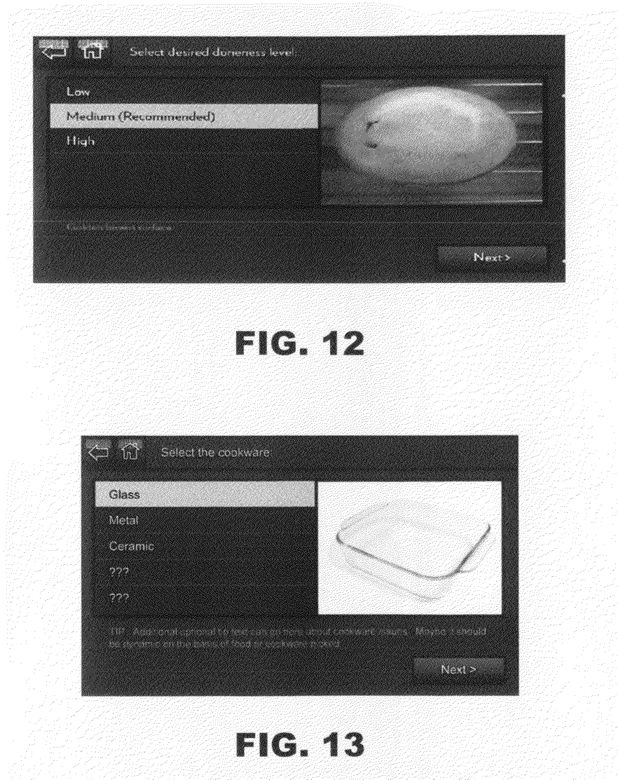

At this point an additional exemplary cooking sequence will be described with reference to FIGS. 6A-8B. As described above, a user has the option of choosing the “Food Wizard/Assistant” from first display screen 102. Once the “Food Wizard/Assistant” option is selected, display 57 automatically shifts to screen 114, as shown in FIG. 6A, wherein a user is prompted to select the type of food to be cooked. As described above, the user may select from a variety of food categories, as shown on the left of the screen. Here, for exemplary purposes, the “All” category has been selected, followed by the “Bread-Biscuits” food item selection. Following the selection of “Biscuits” on screen 114, display 57 shifts to screen 116, as shown in FIG. 6B, whereupon display 57 prompts user to select the desired doneness of the biscuit. Next, a pictorial image of a biscuit is shown for each available doneness level, “Low,” “Medium,” or “High.” A written description for each level of doneness is also provided. If a user selects “Medium”, the pictorial image will show a medium cooked biscuit and describes the biscuit as having a “Golden brown surface.” As shown in FIG. 12, an image of the biscuit at the selected level of doneness is shown in full color. When the selection has been made, the user selects the “Next” button by touching it on display 57.

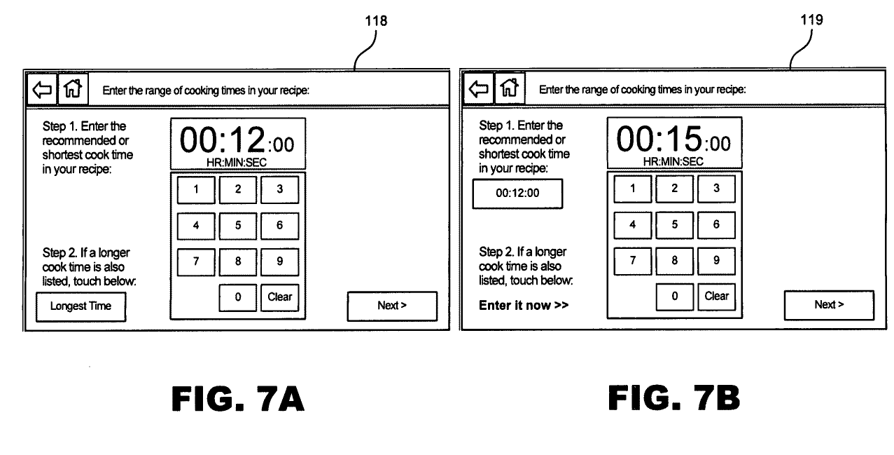

Screen 118, as shown in FIG. 7A, is then displayed to the user. Screens 118 and 119 give the user the option of inputting two cook times based on a recipe or package instructions. That is, as many of today's recipes call for cooking over a range of cook times, oven 10 enables the user to input both a minimum cook time and a maximum cook time through interface 54. To this end, screen 118 prompts the user to select a minimum cook time by touching the appropriate numbers on the touch screen keypad (not separately labeled). After the minimum cook time is set, the user is prompted to proceed to select a maximum cook time if one is provided by the user's recipe. If the user chooses to enter a maximum cooking time by selecting “Longest time,” display 57 shifts to screen 119, as shown in FIG. 7B. At this point, a maximum cooking time parameter can be entered in a manner similar to that described above. In accordance with this feature, the consumer can choose not to enter a maximum cook time. In this situation, the consumer can simply press “Next” on screen 118 to bypass inputting the maximum cook time.

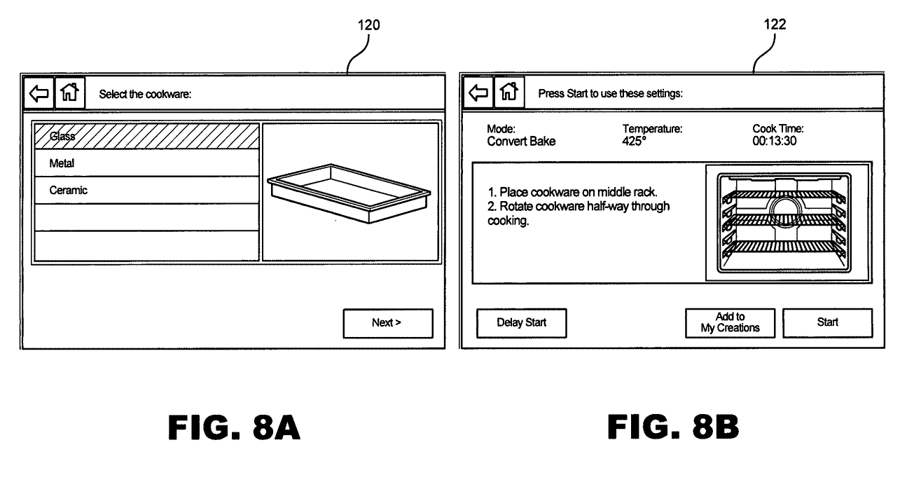

After inputting or bypassing the minimum and maximum cooking times on screens 118 and 119, the user touches “Next” to proceed to screen 120, as shown in FIG. 8A. Screen 120 prompts the user to select the type of cookware that will be used for cooking the food. A list of cookware types is listed on the left of the screen and an image that corresponds to the type of cookware selected is displayed on the right of the screen. For example, types of cookware listed may include “Glass,” “Metal,” or “Ceramic.” As shown in FIG. 13, a color photo of glass bakeware is shown to assist a user in making the appropriate choice. Additional text related to properties of the selected type of cookware may be displayed on the bottom of screen 120. Controller 55 determines the appropriate cook time, from the minimum and maximum times entered previously, based on the type of cookware selected.

When the user has chosen the type of cookware on screen 120, the user selects the “Next” button by touching it on display 57. The next screen 122, as shown in FIG. 8B, displays the settings as determined by controller 55, which are described above in connection with screen 110 on FIG. 5D. In the example shown in FIG. 8B, the selected mode is “Convect Bake,” the proper cooking temperature has been determined to be 425° F. and the configured cook time is 13 minutes and 30 seconds. Additional user instructions may be provided to advise the user to perform a step, such as rotating or flipping the food product, during cooking. Another graphical illustration may be provided to show the user how to perform the step. The user may then touch “Start” to commence the cooking operation or “Delay Start” to commence the cooking operation at a later time. In addition, the user has the option of saving the cooking parameters for the food product by choosing “Add to My Creations.” If the user selects “Start,” screen 122 shifts to a first of a series of cooking screens (FIGS. 9A-9D).

As shown in FIG. 9A, the first cooking screen 124 is a preheating screen showing the cooking mode (“Convect Bake”), current temperature (142° F.), final temperature (425° F.), and cooking time (13:30) required once the preheating is complete. When the preheating is complete, the user touches “Start timer” and display 57 shifts to screen 126, as shown in FIG. 9B, which instructs the user to insert the food and start the timer. The display then changes to screen 128, as shown in FIG. 9C, wherein a timer is displayed to count down the cooking time. The cooking temperature and mode are also displayed on screen 128. When the cooking operation is complete, display 57 shifts to screen 130, as shown in FIG. 9D. Screen 130 gives a user the option of exiting the timer, keeping the food warm by selecting “Keep Warm,” or adding more time by selecting “Add More Time.” By selecting the “Add More Time” operation through screen 130, the user may commence further cooking in order to fine tune or custom finish the final food preparation for desired texture and appearance. A pre-established subsequent cook time may be applied or the user may be given the option of increasing or decreasing this value. Once the actual selection is made, a subsequent screen (not shown) will preferably indicate the time selected, as well as the cook mode selected, and will prompt the user to engage the start button. Thereafter, the screen will generally revert back to screen 128 (FIG. 9C), while displaying the actual cooking operation selected. Display 57 will then go directly to screen 130 (FIG. 9D), wherein the user will again have the option to “Keep Warm,” “Exit Timer,” or provide even further cooking.

Based on the above, it should be apparent that controller 55 and user interface 54, which function to prompt a user to input certain cooking information in a convenient and clear manner including pictorial images and then automatically control oven 10 to perform the desired operation, provide a user friendly system for controlling the operation of oven 10. In addition, oven 10 includes a display 57 for providing a user with simple visual instructions, preferably through pictorial images in color, on how to perform tasks, such as properly inserting a temperature probe or positioning a oven rack. The user is guided through the cooking process in an easy-to-follow, step-by-step, manner. Thus, the likelihood of the cooked food product will be the desired product is greatly increased.

Although described with reference to preferred embodiments of the invention, it should be readily understood that various changes and/or modifications can be made to the invention without departing from the spirit thereof. For instance, although a combination radiant and convection system has been described, other cooking systems, such as a microwave system, could also be integrated into oven 10. In addition, although a touch screen control arrangement has been described, it would be possible to use a roller ball, arrow pointer similar to that available in various notebook-style computers and other types of control screen arrangements known in the art could be employed for this purpose. Therefore, the invention is only intended to be limited by the scope of the following claims.

We claim:

1. A method of controlling a cooking appliance comprising:
presenting in sequence a plurality of display screens, at least a series of said plurality of display screens having pictorial images for prompting a user to input information relating to a food product to be cooked and at least one of said plurality of display screens providing graphical instructions relating to cooking the food product;
determining appropriate cooking parameters based on the information input by the user; and
performing a cooking operation in an oven cavity of the cooking appliance using said appropriate cooking parameters.

2. The method according to claim 1, wherein one of said plurality of display screens prompts a user to input a type of food product.

3. The method according to claim 2, wherein said pictorial images for prompting a user to input information relating to a food product to be cooked prompts a user to input a desired degree of doneness for said food product.

4. The method according to claim 2 wherein said pictorial images for prompting a user to input information relating to a food product to be cooked prompts a user to input the type of cookware to be used.

5. The method according to claim 1, wherein said graphical instructions include an image of a user inserting a temperature probe in a food product.

6. The method according to claim 1, wherein said graphical instructions include an image of an oven rack in a particular position within an oven cavity.

7. The method according to claim 1, wherein one of said plurality of display screens prompts a user to input a minimum cooking time for a cooking operation.

8. The method according to claim 7, wherein one of said plurality of display screens prompts a user to input a maximum cooking time for a cooking operation.

9. The method according to claim 1, wherein information inputs from the user are received through a touch screen.

10. The method according to claim 1, wherein determining the appropriate cooking parameters based on the information input by the user includes determining the appropriate settings for bake, broil and convection heating elements.

11. A method of controlling a cooking appliance comprising:
presenting a user with display screens presenting sequential pictorial images for prompting a user to input information relating to a food product to be cooked;
presenting a user with at least one display screen providing a graphical instructions relating to cooking the food product, said graphical instructions being dependent on the information input by the user;
determining appropriate cooking parameters based on the information input by the user; and
performing a cooking operation in an oven cavity of the cooking appliance using said appropriate cooking parameters.

12. The method of claim 11, wherein said display screens having the pictorial images for prompting a user to input information relating to the food product to be cooked prompts a user to input a desired degree of doneness for said food product.

13. The method of claim 11, wherein said pictorial images for prompting a user to input information relating to the food product to be cooked prompts a user to input the type of cookware to be used.

14. The method of claim 11, wherein said at least one display screen providing a graphical instructions relating to cooking the food product displays an image of a user inserting a temperature probe in a food product.

15. The method of claim 11, wherein said at least one display screen providing a graphical instructions relating to cooking the food product displays an image of an oven rack in a particular position within an oven cavity.

16. The method of claim 11, wherein one of said plurality of display screens prompts a user to input a minimum cooking time for a cooking operation.

17. The method of claim 16, wherein one of said plurality of display screens prompts a user to input a maximum cooking time for a cooking operation.

18. The method of claim 11, wherein information inputs from the user are received through a touch screen.

19. The method of claim 11, wherein determining the appropriate cooking parameters based on the information input by the user includes determining appropriate settings for bake, broil and convection heating elements.

20. In a cooking appliance including an oven cavity adapted to be used in cooking foods, a control system comprising:
a display device presenting available programming options to a user by displaying a sequence of pictorial images for prompting a user to input information relating to a food product to be cooked, said display device also presenting graphical instructions relating to cooking the food product; and
a controller for establishing a cooking operation within the oven cavity based on the selected programming options.
